(19) United States
(12) Patent Application Publication
(10) Pub. No.: US 2005/0010632 A1
(43) Pub. Date: Jan. 13, 2005

(54) DIGITAL SIGNAL PROCESSOR BASED ON JUMPING FLOATING-POINT ARITHMETIC

(76) Inventors: Yung-Chun Lei, Hsin-Chu City (TW); Yu-Chu Chen, Hsin-Chu City (TW); Yu-Chi Chang, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,398

(22) Filed: Jul. 8, 2004

(30) Foreign Application Priority Data
Jul. 9, 2003 (TW) 092118757

(51) Int. Cl. G06F 7/38

(52) U.S. Cl. 708/670

(57) ABSTRACT

A digital signal processor for processing a plurality of digital data in a fixed-point representation or a jumping floating-point representation. The digital signal processor includes a multiplication circuit, an extracting/shifting device, a plurality of representation converters, and an arithmetic unit. The multiplication circuit is used to generate a long bit-length digital data by multiplying two short bit-length digital data with each other. The extracting/shifting device is electrically connected to the multiplication circuit for transforming the long bit-length digital data in jumping floating-point representation to a long bit-length digital data in fixed-point representation. Each representation converter is used to transform a digital data between the fixed-point representation and the jumping floating-point representation. The arithmetic unit is used to operate a plurality of digital data.

### BACKGROUND OF INVENTION

1. Field of the Invention

The present invention relates to a digital signal processor and a related method for processing a plurality of digital data, and more specifically to a digital signal processor and a related method for processing and transforming a plurality of digital data between a fixed-point representation and a jumping floating-point representation through jumping floating-point arithmetic.

2. Description of the Prior Art

With the rapid development of very large scale integrated (VLSI) circuits and computer technology in the past few years, companies in the field of electronics and information successively introduce digital signal processors (DSPs) with various functions and styles. DSPs generally have the advantages of good flexibility, high accuracy, and powerful capability. Though DSPs are broadly applied in various fields, there is no such thing as one DSP design that can satisfy all or even most of the application demands. Design engineers take factors such as capability, cost, integrity, difficulty of development, power consumption and so on, into consideration while designing a DSP.

Generally speaking, DSPs are all used to process digital data. But different DSPs have different characteristics implemented in various applications. DSPs are generally separated into two kinds: the fixed-point DSP and the floating-point DSP, according to the type of digital data that the DSP processes and the adopted arithmetic rule. The fixed-point DSP makes use of the fixed-point arithmetic, and the digital data processed are represented in the fixed-point representation. The word fixed-point means that the position of the decimal point is fixed, and the digital data having the fixed-point representation can be indicated as an integer or a decimal number between 1.0 to +1.0 according to the position of the decimal point. The floating-point DSP uses the floating-point arithmetic, and the digital data processed are represented in the floating-point representation, with the number being represented as a mantissa M with an exponent E: M×2^{E}. Although the floating-point arithmetic is much more complex, it widens the data dynamic range to a broader extent, and such a broad data range and high accuracy reveal the huge potential of the market. While the factors of cost and power consumption are taken into consideration, the fixed-point DSP implemented in general consumption electronic appliance will still firmly remain in an advantageous position.

FIG. 1 is a block diagram of a prior art fixed-point arithmetic DSP 10. This DSP 10 is capable of processing a plurality of digital data having the fixed-point representation, wherein the digital data can be represented with both integer and decimal representation. According to the number of bits these digital data have, they are separated into n-bit digital data and 2n-bit digital data, where n is an integer larger than zero. The DSP 10 includes a data receiving end 12, a multiplication circuit 16, a multiplication shifter 18, a first shifter 14, a second shifter 24, a multiplexing arithmetic module 20, a storage instrument 22, and a data writing-in end 26. The data receiving end 12 receives 3 n-bit digital data from memory buses or other external data bus or some specific circuits. Two digital data are sent to the electrically connected multiplication circuit 16, in which the two n-bit digital data in the fixed-point representation are multiplied and a 2n-bit digital data in the fixed-point representation is generated. The multiplication shifter 18 electrically connected to the multiplication circuit 16 will adjust the decimal point position of the 2n-bit digital data, according to the programmer's setting, after multiplication and generate the first digital data of 2n-bit. Meanwhile, the data receiving end 12 sends an n-bit digital data to the first shifter 14. The first shifter 14 is to process this n-bit digital data having the fixed-point representation according to a sign extension as well known in the art to generate the second digital data of 2n-bit having the fixed-point representation, and shift according to programmer's setting. The sign extension means, for example, the higher bits are stuffed with zeroes if an 8-bit binary positive (n=8): (00010100) is transformed into a 16-bit one (n=16); that is, to stuff the highest 8 bits with zeroes, becoming (00000000 00010100). On the Other hand, if a negative is represented as a binary complement, then the extended 8 bits will be stuffed with ones. For example, a binary negative (11101100) will result in (11111111 11101100) according to this procedure to stuff the bits with ones after transformation.

The multiplexing arithmetic module 20 includes a selecting apparatus 19 and an arithmetic unit 21. The selecting apparatus 19 electrically connected to the first shifter 14 and the multiplication shifter 18 is used to choose between the first and second digital data of 2n-bit as an output. The selecting apparatus 19 can be realized by a multiplexer in practical embodiment. The arithmetic unit 21 electrically connected to the selecting apparatus 19 is to receive either the first digital data or the second digital data selected by the selecting apparatus 19. Moreover, the arithmetic unit 21 includes another input end, which is to receive a third digital data consisted of 2n bits sent from the storage instrument 22. Therefore, the arithmetic unit 21 can perform operations to the digital data (the third digital data and the first or the second one.) Then, the arithmetic unit 21 outputs a fourth processed digital data consisted of 2n bits to the storage instrument 22, which is used to store the plurality of digital data processed by the multiplexing arithmetic module 20. The storage instrument 22 can be accomplished by an accumulator or register in practical embodiment. Finally, the second shifter 24 transforms the 2n-bit digital data in fixed-point representation into n-bit digital data in fixed-point representation according to programmer's setting, and this n-bit digital data is written into a memory device or other devices via the data writing-in end 26.

The basic concept and structure of the conventional fixed-point DSP 10 is disclosed in various documents. For example, Kiuchi and et al proposed a correction process for digital data in the form of integers in U.S. Pat. No. 5,884,092, “System for maintaining fixed-point data alignment within a combination CPU and DSP system,” which makes use of an instruction to provide relative information when digital data are being processed in bits. This prior art method can avoid the redundant shifting operations and enhance the operation speed. Moreover, there are also documents discussing fixed-point arithmetic, such as implementation of fixed-point arithmetic with the concept of mantissa and exponent in the floating-point representation proposed by Takano and et al in U.S. Pat. No. 5,524,089 titled “Logarithm computing circuit for fixed-point numbers”. This implementation focuses on the transformation between binary and decimal representation in order to minimize the square measure and complexity of relative circuit.

According to the prior art described above, the currently available fixed-point DSPs still have some drawbacks to improve so as to receive more popularity. One of the major markets of the fixed-point DSP nowadays is embedded systems; with this application, the memory size required is smaller than that of typical ones. When the fixed-point DSP 10 shown in FIG. 1 is implemented with smaller memory, guantization errors may occur due to the limited memory size. Referring to FIG. 1, the product is a 2n-bit digital data when the two n-bit digital data are multiplied with each other in the multiplication circuit 16. After a series of processes, the highest n bits are kept while the lowest n bits are removed if the second shifter 24 transforms the 2n-bit digital data in decimal representation into an n-bit one when storing it into the n-bit memory. To illustrate, a 48-bit binary number: 0x004444ffffff represented in hexadecimal representation is taken as an example. When this number is transformed to a 24-bit digital data by eliminating the lowest 24 bits, it becomes 0x004444000000, which has quite some difference from the original number, and such difference leads to quantization errors. Quantization errors may induce discontinuousness or distortion in digital signal magnitude, and also other unfavorable impacts, which restrain the applications of the fixed-point DSP. Increasing the number of bits of DSP or improving the floating-point DSP in order to minimize the quantization errors is generally accompanied by much higher hardware cost. Furthermore, modifying the program code of DSP in order to reduce quantization errors will make the program more complicated and abate the efficiency of the DSP.

### SUMMARY OF INVENTION

It is therefore an objective of the invention to provide a DSP with jumping floating-point arithmetic, and a jumping floating-point representation to operate a plurality of digital data to solve the above-mentioned problem.

According to the embodiment, a novel jumping floating-point representation (JFP) is provided by combining and improving the fixed-point representation and the floating-point representation. The novel jumping floating-point representation could be included in a DSP and realized as a hardware device to accomplish the transformation from long bit-length digital data into short bit-length ones with fewer repeated bits and storing them into a memory module. Afterwards, the short bit-length digital data could be more accurately and efficiently transformed back to long bit-length ones. Thus the Quantization error will be reduced at low cost.

The objective of the claimed invention is to provide a DSP to process a plurality of digital data in a plurality of representations, with at least the fixed-point representation and the jumping floating-point representation included. The DSP proposed includes a multiplication circuit to multiply at least two short bit-length digital data and generate a long bit-length digital data; an extracting/shifting device electrically connected to the multiplication circuit to transform the long bit-length digital data in jumping floating-point representation into long bit-length digital data in fixed-point representation; a plurality of representation converters to accomplish the digital data transformations between the fixed-point representation and the jumping floating-point representation using the jumping floating arithmetic; and an arithmetic unit to operate a plurality of digital data.

Another objective of the invention is to provide a method of data transformation from long bit-length digital data in fixed-point representation into short bit-length digital data in jumping floating-point representation. The method includes: (a) magnifying the shifting of the long bit-length digital data in fixed-point representation N bits according to the absolute value of the long bit-length digital data, where N is an integer larger or equal to zero and varies with the absolute value of the long bit-length digital data; (b) eliminating an estimated number of bits of the long bit-length digital data; (c) setting up a tail mark corresponding to the value of N to generate the short bit-length digital data in jumping floating-point representation.

Another objective of the invention is to provide a DSP for processing a plurality of digital data which have a plurality of number representations, including the fixed-point representation and the jumping floating-point representation. The DSP includes a data receiving end to receive a plurality of short bit-length digital data; a multiplication circuit which is electrically connected to the data receiving end, used to multiply the two short bit-length digital data in fixed-point representation, and to generate a long bit-length digital data in jumping floating-point representation; an extracting/shifting device which is electrically connected to the multiplication circuit and transforms the long bit-length digital data in jumping floating representation into long bit-length digital data in fixed-point representation; the first representation converter which is electrically connected to the data receiving end and used to transform short bit-length digital data in jumping floating-point representation or fixed-point representation into long bit-length digital data in the same representation; a multiplexing arithmetic module which is electrically connected to the first representation converter and the extracting/shifting device and used to execute the selection and operation; a storage instrument which is electrically connected to the multiplexing arithmetic module and used to store the plurality of digital data processed by the multiplexing arithmetic module; a second representation converter which is electrically connected to the storage instrument and used to transform a long bit-length digital data in fixed-point representation into a short bit-length digital data in jumping floating-point representation; and a data writing-in end which is used to write the short bit-length digital data with jumping floating-point representation in a memory device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a prior art fixed-point DSP.

FIG. 2 is a block diagram of a DSP according to the present invention.

FIG. 3 is a diagram illustrating digital data in a jumping floating-point representation according to embodiment of the present invention.

FIG. 4 is a detailed diagram illustrating the jumping floating-point representation shown in FIG. 3.

FIG. 5 is another detailed diagram illustrating the jumping floating-point representation shown in FIG. 3.

FIG. 6 is a flow chart of a method according to the embodiment of the present invention.

FIG. 7 is a detailed flow chart illustrating the method shown in FIG. 6.

FIG. 8 is a flow chart of another method according to the embodiment of the present invention.

FIG. 9 is a block diagram of part of elements within the DSP shown in FIG. 2.

FIG. 10 is a detailed block diagram of the DSP structure shown in FIG. 2.

FIG. 11 is another block diagram of the DSP structure shown in FIG. 2.

### DETAILED DESCRIPTION

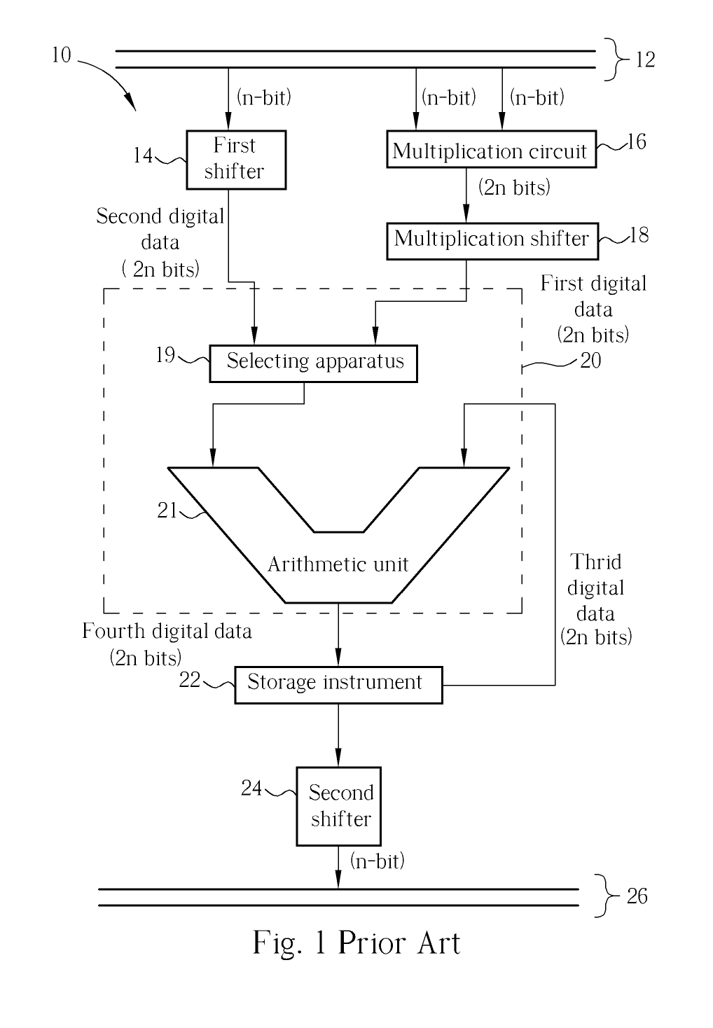

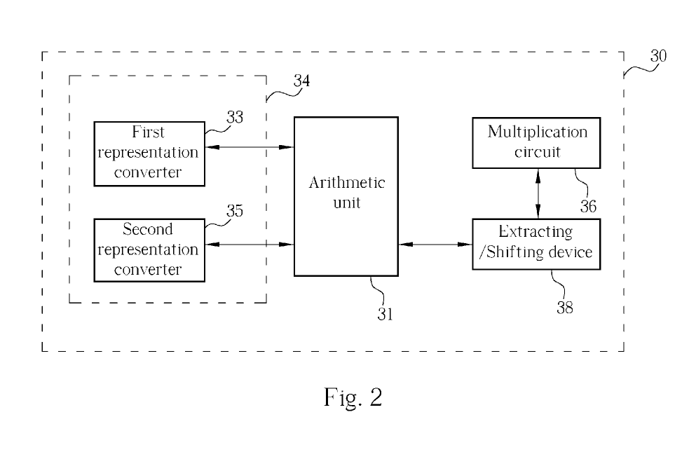

The characteristic of the claimed invention is based on the jumping floating-point arithmetic, which accomplishes the transformation between the fixed-point representation and the jumping floating-point representation (JFP) proposed in this invention and reduces the potential quantization errors. The DSP in the embodiment can process the digital data in either the fixed-point representation or the jumping floating-point representation. FIG. 2 is a block diagram of a DSP 30 according to the embodiment. As mentioned above, the DSP 30 can process the digital data in either the fixed-point or the JFP representation. In this embodiment, digital data can be separated into long bit-length digital data (eg. the 2n-bit digital data shown in FIG. 1), and short bit-length digital data (eg. the n-bit digital data shown in FIG. 1). The number of bits of the digital data is not restricted to the two kinds of long bit-length and short bit-length digital data mentioned above. The DSP 30 includes a multiplication circuit 36, an extracting/shifting device 38, a representation converter 34, and an arithmetic unit 31. The multiplication circuit 36 is used to multiply the two short bit-length digital data and generate a long bit-length digital data; while the extracting/shifting device 38, which is electrically connected to the multiplication 36, is used to shift the long bit-length digital data to restore the shifting of the jumping floating-point representation. The output of 38 is a long bit-length digital data having the fixed-point representation. The representation converter 34 includes the first representation converter 33 and the second representation converter 35. The first representation 33 and second representation 35 with the jumping floating-point arithmetic could perform the digital data transformation between the fixed-point representation and the jumping floating-point representation. The arithmetic unit 31, which is coupled to the extracting/shifting device 38, the first representation converter 33, and the second representation converter 35, is used to process the received digital data. Please note that the representation of the digital data processed by the arithmetic unit 31 is not restricted to only the fixed-point representation and the jumping floating-point representation.

The number of converter units within the representation converter 34 is not limited. In other words, more representation converters other than the first and second representation converter 33, 35 may be included in the representation converter 34. The function of each representation converter 34 can be designed to transform the digital data in fixed-point representation into those in jumping floating-point representation, or transform the digital data in jumping floating-point representation into those in fixed-point representation. Therefore, the representation converter 34 will receive and output the digital data, which is needed in the DSP 30, in the jumping floating-point representation or the fixed-point representation. That is to say, in the DSP 30 of this embodiment, the way of connection among the first representation 33, the second representation 35, and other elements is not fixed. It is not necessary to restrict the connection of the two representation converters with the arithmetic unit 31. They can be flexibly connected to other elements depending on the arithmetic procedures. For example, if the long bit-length digital data in fixed-point representation after processing by the arithmetic unit 31 is expected to be transformed into the short bit-length digital data in order to be written in an external memory, the second representation converter 35 can be designed to carry out the function of transforming the long bit-length digital data in fixed-point representation into short bit-length digital data in the jumping floating-point representation. The errors that occur in the transformation between the short bit-length digital data written in and the original long bit-length digital data may be greatly minimized because of the low quantization-error characteristic of the jumping floating arithmetic.

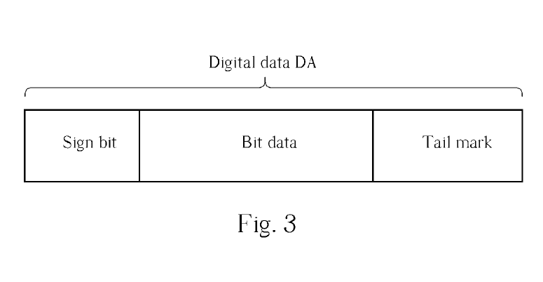

The jumping floating-point arithmetic and the jumping floating-point representation according to the embodiment are disclosed below, and the hardware part of the DSP applied with the jumping floating arithmetic and more technical details are introduced. The jumping floating-point representation here is a novel number representation other than the conventional fixed-point representation and the conventional floating-point representation. The jumping floating-point representation represents a number as a decimal number between −1.0 to +1.0. And based on the concept of floating-point representation, an exponent named tail mark in the present invention using one or more bits is included. Besides, the other bits in the digital data are called the mantissa. Therefore in the jumping floating-point representation, a digital data DA has a sign bit field, a bit data field, and a tail mark field. The sign bit field indicates the sign of the number; the bit data field indicates the mantissa of the number; and the tail mark field indicates the exponent of the number. The concept of jumping floating-point representation is that the number of bits of the tail mark in the digital data with jumping floating-point representation is modified by comparing with the original value of the digital data before transformation. If the original value before transformation is larger, the number of bits within the tail mark is fewer. If the original value is smaller, the number of bits within the tail mark becomes greater in order to displace the excessively repeated bits. Therefore there will not be too many repeated bits occupying the higher bits of the original number. FIG. 3 is a diagram illustrating a digital data DA in the jumping floating-point representation according to the embodiment. The digital data DA includes a sign bit, bit data that has the most number of bits, and a tail mark. The number of bits of tail mark is not fixed as mentioned above; the sign bit is the highest bit of the digital data DA and used to determine whether the data DA is positive or negative. The digital data DA is a positive if the sign bit is zero while the digital data DA is a negative if the sign bit is one. When the original value is small, the number of repeated bits needs to be determined. To determine the number of repeated bits, the bits from the next bit of the sign bit are taken into consideration. Those bits from the next bit of the sign bit having the same value as that of the sign bit will be regarded as the repeated bits.

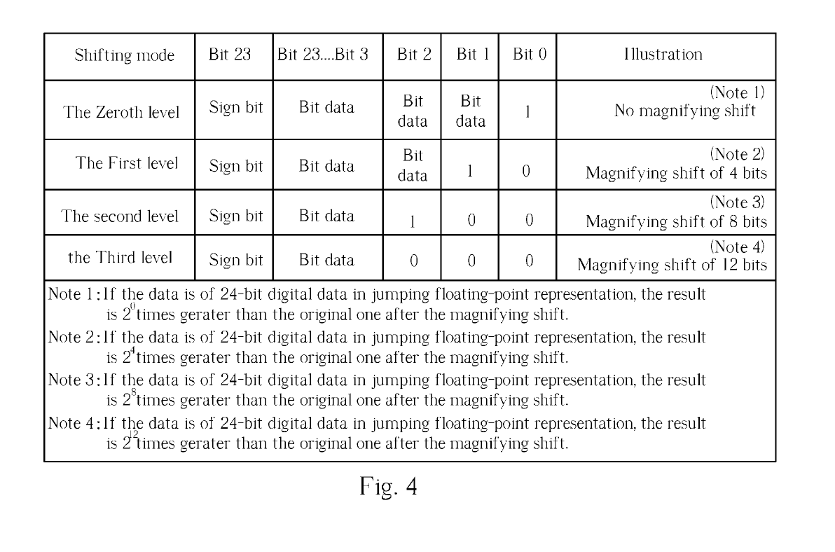

The digital data shown in FIG. 3 corresponds to the short bit-length digital data in the jumping floating-point representation in FIG. 2. As described in FIG. 2, the digital data DA shown in FIG. 3 is the result of the long bit-length digital data in the jumping floating-point representation after being processed by the jumping floating-point arithmetic according to the present invention. FIG. 4 is a detailed diagram illustrating the jumping floating-point representation shown in FIG. 3. In the embodiment shown in FIG. 4, the number of bits of the digital data is set as 24, and the representation of the digital data in this figure is called, “Regular Jumping Floating-point Representation”, which is a special case of the jumping floating representation in this embodiment. The word “regular” means all of the numbers of shifting-bits are multiple of a base number. In this example, it is 4. The details are described below. The 24-bit digital data in this embodiment is the result after transformation from a long bit-length digital data in the fixed-point representation. The number of bits of this long bit-length digital data can be set as 48 bits or other numbers of bits. For example, if a 48-bit digital data in the fixed-point representation is to be transformed into a 24-bit digital data in the representation shown in FIG. 4, the jumping floating-point arithmetic will shift N bits of the 48-bit digital data according to the absolute value of this 48-bit digital data, where the value of N varies with the absolute value of this 48-bit digital data. In the following paragraphs, this shift process mentioned above will be mentioned as “magnifying shift”. The value of N is smaller if the absolute value of the 48-bit digital data is larger, and the value of N is larger if the absolute value of the 48-bit digital data is smaller. The regular jumping floating-point representation includes a shifting mode and a fixed number of bits for the magnifying shift in each level. In the embodiment shown in FIG. 4, we shift 4 bits more in the next shifting level. When the number of shifting level is set to 4 (eg. from the zero^{th} level S0 to the third level S3), the four shifting levels S0-S4 respectively correspond to different magnifying shift, which means to shift 0, 4, 8 and 12 bits respectively in each level. This method of setting up a fixed number of bits corresponding to each level is the technical feature of the regular jumping floating-point representation.

In our case, we use 2's complement to represent the signed number, but other method of signed number representation is not excluded from our invention. The following example will use the concept of 2's complement signed number. In the case of other representation of signed number, the detail may be different.

Comparing FIG. 4 with FIG. 3, the digital data corresponding to each level of the shifting mode includes a sign bit. The value of this sign bit is the same as that of the original 48-bit digital data. This sign bit is compared with the other bits in the 48-bit digital data to determine a specified shifting mode and the corresponding value of N when the 48-bit digital data is transformed into a 24-bit one in regular jumping floating-point representation. For example, a number is represented in the hexadecimal representation as 0x004444ffffff. It is well-known that one bit in hexadecimal representation stands for four bits in the binary representation. The three bits on the left 004 is a twelve-digit number 000000000100 in 2's complement representation, and the left-most bit is the sign bit. There are eight zeroes, which has the same value as that of the sign bit, after the sign bit. So the shifting mode can be set up as the second level S2, which means a magnifying shift for shifting 8 bits during the format transformation. In order to transform the 24-bit digital data to a 48-bit one, the lowest 24 bits are eliminated and a tail mark corresponding to the second level of the shifting mode is added.

As shown in FIG. 4, the tail mark is put at the end of the digital data (the lowest bit). The number of bits of the sign bit is not fixed, and each level of shifting mode corresponds to a specific tail mark. In this embodiment, the shifting mode includes four levels; that is, three bits (bit 0, bit 1, and bit 2) at most are assigned as tail marks for the different levels S0-S3. When the original value of the 48-bit digital data is large, the jumping floating-point arithmetic does not apply the magnifying shift, and the lowest bit (bit 0) is assigned by 1, which is regarded as the zero^{th} level S0 of the shifting mode. In the first level S1 of the shifting mode, the original value is smaller than the zero^{th} level S0 of the shifting mode. After the original 48-bit digital data experiences a magnifying shift of 4 bits (which means to be multiplied by 24), the highest 22 bits are placed from bit 23 to bit 2 in a 24-bit digital data and bit 1 and bit 0 are respectively assigned “1” and “0”, which fits in with digital data in the regular jumping floating-point representation. All the procedures are the same in the second level S2 of the shifting mode. The tail mark is assigned “000” in the third level S3 of the shifting mode. If the value 0x004444ffffff of 48-bit digital data is taken as an example, this number experiences a magnifying shift of eight bits, and the lowest 24 bits are eliminated. Finally the 24-bit digital data: 0x4444fc in regular jumping floating representation is accomplished after adding the tail mark “100”.

The data format of the tail mark, the total number of bits of the tail mark, and the position of the tail mark are not restricted. The tail mark shown in FIG. 4 is just one of the best embodiments according to the present invention. This design of the tail mark in the embodiment has some advantages: first, the shifting mode is determined by the last bit (bit 0). That is, the position of a binary value “1” can be used to determine the adopted level of the shifting mode. For example, the digital data is of the second level S2 of the shifting mode if bit 0 and bit 1 are both “0”, bit 2 is “1”, and the original data is magnifying shifted 8 bits during the transformation. The digital data is of the third level S3 if bit 0, bit 1 and bit 2 are all “0”, and twelve bits are truncated during the transformation. It is obvious that an average value of the minimum value “00000 . . . 0.0” and the maximum value “11111 . . . 1” (in binary representation) of the truncated bits is “10000 . . . 0.0”. So, whatever the bits truncated in the transformation are (such as the lowest 24 bits eliminated in the embodiment), the tail mark (the highest bit is set to “1” while the others are set to “0”) can represent an average value of the truncated bits during the transformation. In other words, the tail mark is capable of minimizing the difference between the original value and that after elimination. When a digital data with a representation shown in FIG. 4 is processed, the tail mark is included as one part of the digital data needed to be processed. If each bit of a 48-bit digital data records a binary value “0”, the value of the transformed digital data should correspond to 0. Therefore, the intention of setting the tail mark as “000” in the third level S3 of the shifting mode is to prevent errors resulting from any of the tail mark's non-zero bit. That is, if the value recorded by the original long bit-length digital data is equal to 0, the value recorded by the short bit-length digital data transformed according to the third level S3 of the shifting mode still equals 0.

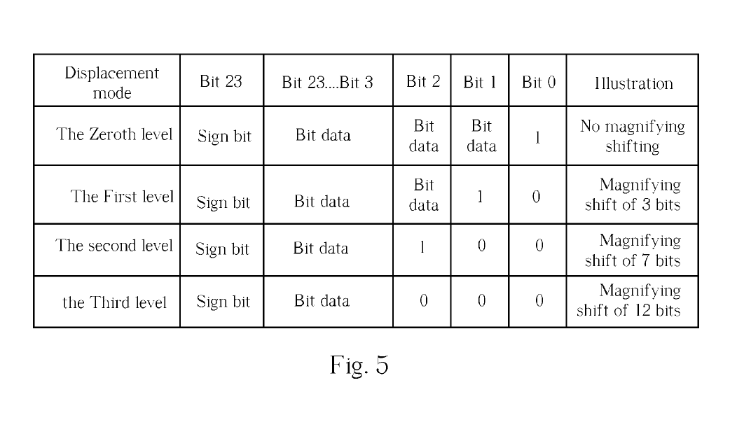

The jumping floating-point representation in the present invention further includes a “Non-Regular Jumping Floating-point Arithmetic”, which is somewhat different with the “Regular Jumping Floating-point Arithmetic” shown in FIG. 4. This representation does not have a fixed number of shifted bits in each level of the shifting mode. FIG. 5 is another detailed diagram illustrating the jumping floating-point representation shown in FIG. 3. The basic concept of the non-regular jumping floating-point representation is the same as the embodiment shown in FIG. 4. It is used for magnifying shifting N bits of a long bit-length digital data (eg. The 48-bit digital data) according to its absolute value. The value of N becomes smaller when the absolute value of the original value becomes greater and vice versa in order to eliminate excessive repeated bits and retain more effective bits. Referred in FIG. 5, the regular jumping floating representation in this embodiment also includes four levels for the shifting mode. The number of bits shifted by the magnifying shift in the zero^{th} level N0 to the third level N3 of the shifting mode is 0, 3, 7, 12, which are not the same as those of the previous embodiment, 0, 4, 8, 12. Other than that, the features of this embodiment are mainly the same as those in the embodiment shown in FIG. 4. In addition, the function of the sign bit and the tail mark also corresponds to that described in the embodiment shown in FIG. 4.

Be aware that the number of levels for the shifting modes in each of the embodiments shown in FIG. 4 and FIG. 5 is not restricted to four. For example, the embodiment in FIG. 4 may have a fourth level for the shifting mode, a fifth level for the shifting mode, and etc. According to the basic concept of the regular jumping floating representation, we can define that the number of shifted bits for each level of the shifting mode be fixed as a multiple of a positive integer P, and L levels are set up, where L is an integer greater or equal to zero. Therefore, the zero^{th} level of the shifting mode applies no magnifying shift to digital data, and the first level of the shifting mode applies a magnifying shift of shifting P bits of the digital data. When the Lₜₕ level of the shifting mode is chosen, the digital data experiences a magnifying shift used to shift (L−1)*P bits, where the value of (L−1)*P is less than the bit-length of the original digital data. If the total number of the defined levels increases, the total number of bits allocated to a tail mark should be increased in order to adequately displace the repeated bits in the original digital data. Additionally, when the value of the original digital data becomes greater, the fewer number of bits the tail mark has means more effective bits are retained from the original digital data. On the contrary, when the value of the original digital data becomes smaller, the greater number of bits the tail mark has makes it seem like fewer effective bits are retained after transformation. In fact, the tail mark can make use of displacing a large number of repeated bits, which efficiently retains more effective bits in the original number. Therefore using the jumping floating-point arithmetic in the present invention will retain more effective bits from the original long bit-length digital data when the long bit-length digital data such as a 48-bit digital data having the fixed-point representation is transformed into a corresponding short bit-length digital data such as a 24-bit digital data having the jumping floating-point representation. That is, in the situation of the total bits of the digital data before and after transformation are the same, the jumping floating-point representation makes the DSP process the inputted data with better accuracy. In addition, the complexity of the prior art fixed-point representation is lessened through the claimed jumping floating-point representation.

The tail mark of this invention is also not restricted to the method mentioned in former parts. The tail mark can start from more than one bits. For example, we can use 2 bits as the tail mark in level 0, 1, 2 and more bits in other level. The spirit of tail mark design includes: First, to use lesser bits when absolute value is smaller, and to use more bits when absolute value is larger. Second, we can identify the level of JFP from the tail mark. The tail mark design in our embodiment is a better one we thought.

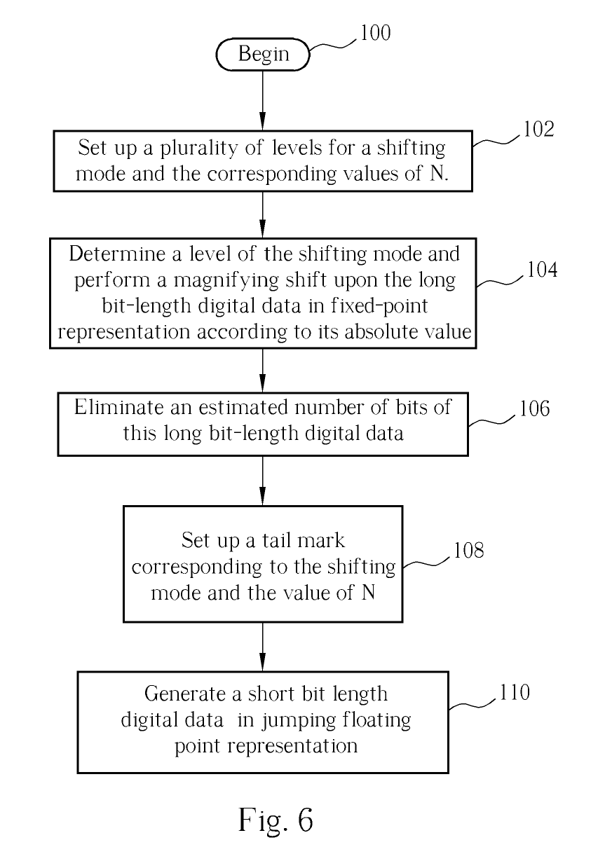

As mentioned above, the jumping floating-point arithmetic according to the present invention is applied to the DSP shown in FIG. 2 for transforming a long bit-length digital data having the fixed-point representation into a short bit-length digital data in the jumping floating-point representation including the regular jumping floating-point representation and the non-regular jumping floating-point representation. The method for performing the format transformation is illustrated in FIG. 6. FIG. 6 is a flow chart illustrating a method according to the present invention. The method includes following steps:
Step 100: Begin;
Step 102: Set up a plurality levels for a shifting mode. Each level of the shifting mode corresponds to a specific value of N, wherein N is an integer greater or equal to zero;
Step 104: Determine a level of the shifting mode according to an absolute value of this long bit-length digital data, and perform a magnifying shift to shift N bits of the long bit-length digital data in the fixed-point representation according to the selected level of the shifting mode. Here are the principles of determining the shifting mode and the value of N: the greater the absolute value of the original long bit-length digital data is, the smaller the value of N should be; the smaller the absolute value of the original long bit-length digital data is, the greater the value of N should be. Meanwhile, the selection of the value of N and the level of the shifting mode is determined by comparing a sign bit with other bits in this long bit-length digital data;
Step 106: Eliminate an estimated number of bits of this long bit-length digital data so that the number of bits after elimination is the same as that of a target short bit-length digital data;
Step 108: Set up a tail mark corresponding to the selected shifting mode and the value of N in order to generate a short bit-length digital data having the jumping floating-point representation; and
Step 110: Accomplish the transformation of the jumping floating-point arithmetic.

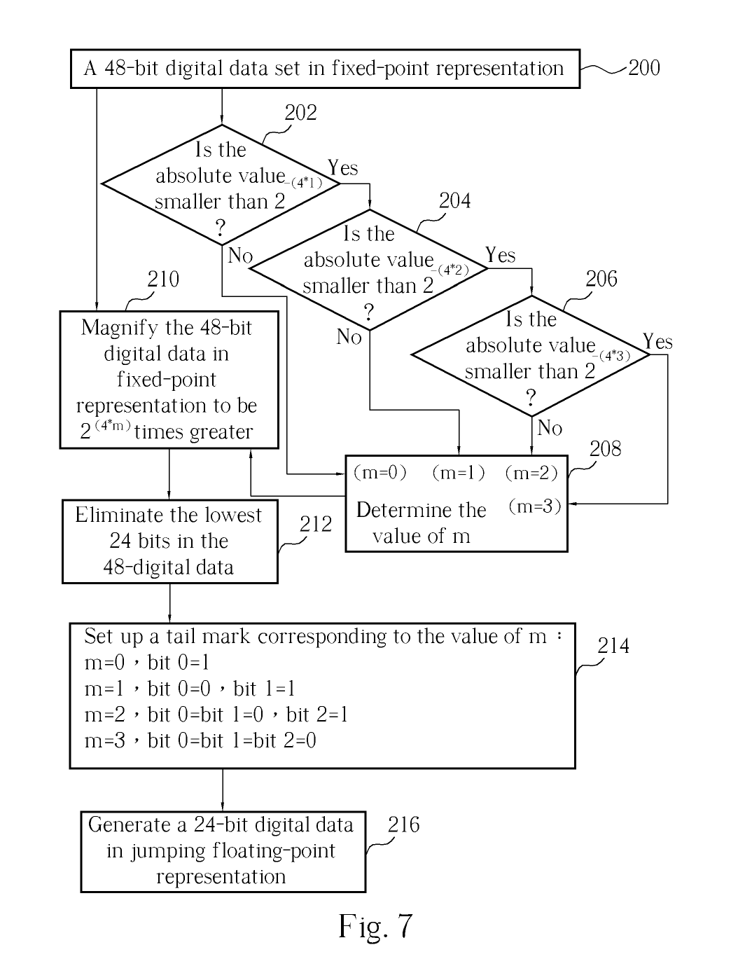

Based on the embodiment shown in the FIG. 4 and the operating flow described in FIG. 6, FIG. 7 is a detailed flow chart illustrating the method of transforming a 48-bit digital data having the fixed-point representation into a 24-bit digital data having the floating-point representation. As shown in FIG. 7, the method according to the present invention includes following steps:
Step 200: Provide a 48-bit digital data having the fixed-point representation;
Step 202: Determine if an absolute value of this 48-bit digital data is smaller than 2 (4*1); if so, proceed to step 204. If not, determine a number m as zero, set a level of the shifting mode as the zero^{th} level N0, and then proceed to step 208;
Step 204: Determine if the absolute value of this 48-bit digital data is smaller than 2 (4*2); if so, proceed to step 206. If not, determine a number m as one, set the level of the shifting mode as the first level N1, and then proceed to step 208;
Step 206: Determine if the absolute value of this 48-bit digital data is smaller than 2^{-(4*3)}. If so, determine a number m as three, set the level of the shifting mode as the third level N3, and then proceed to step 208. If not, determine a number m as two, set the level of the shifting mode as the second level N2, and then proceed to step 208;
Step 208: According to the absolute value of this 48-bit data, cooperating with steps 202-206, determine the number m, and proceed to step 210 after determining the number m;
Step 210: Magnify the 48-bit digital data to be 2^{-(4*m} times greater, that is, perform a magnifying shift to shift (4*m) bits of this digital data;
Step 212: Eliminate the last 24 bits of the original 48-bit digital data and make it a 24-bit digital data;
Step 214: Attach a tail mark corresponding to the value of m. The bit 0 records “1” when the value of m is 0; the bit 0 records “0” and the bit 1 records “1” when the value of m is 1; both the bit 0 and bit 1 record “0”, and the bit 2 records “1” when the value of m is 2; all of the bit 0, bit 1 and bit 2 record “0” when the value of m is 3; and
Step 216: Generate a 24-bit digital data in jumping floating-point representation to accomplish the transformation performed according to the jumping floating-point arithmetic;

The characteristic of the jumping floating-point arithmetic, which means a transformation between the fixed-point representation and jumping floating-point representation, is well accomplished when this short bit-length digital data with jumping floating-point representation is expected to return to the original long bit-length digital data having the fixed-point representation while the long bit-length digital data in fixed-point representation is transformed to the short bit-length digital data in jumping floating-point representation. The objective is achieved by reversing the transformation procedure mentioned before. According to the tail mark of the short bit-length digital data, N bits of the short bit-length digital data is shifted by a minifying shift. In addition, the value of each bit within the N bits is determined according to the sign bit of the short bit-length digital data. Meanwhile an estimated number of bits are supplemented to the short bit-length digital data so that it has the same number of bits as that of the original long bit-length digital data. The value of each bit supplemented must be the same as that of the sign bit. Take a 24-bit digital data in regular jumping floating-point representation: 0x00444fc (hexadecimal representation) for example. This 24-bit digital data is to be transformed back to the 48-bit digital data having the fixed-point representation. Since the value of the last bit c of the 24-bit digital data in hexadecimal representation corresponds to the value of “1100” in binary representation, the values of bit 0 and bit 1 are both 0, and the value of bit 2 is 1, which is equivalent to a tail mark “100”. Referred in FIG. 4, this digital data is distinguished as the second level S2 of the shifting mode, which means that it had been magnified through shifting 8 bits during the transformation. The 48-bit digital data 0x004444fc0000 having the fixed-point representation is generated after the minifying shift is performed to shift 8 bits of this 24-bit digital data. It is clear that the 24-bit digital data is divided by 2⁸. Then, zeroes are added to the 24-bit digital data according to the sign bit until the total number of bits becomes 48.

Comparing 0x4444fc with the original number 0x004444ffffff, the number 0x004444fc obtained after transformation is somewhat different from the original number. But, compared with the number 0x004444000000 obtained from the prior art fixed-point arithmetic, the jumping floating-point arithmetic according to the present invention can greatly reduce the quantization errors. Smaller size in hardware for storing data and processing digital data with greater accuracy are accomplished without adding extra software and hardware resources.

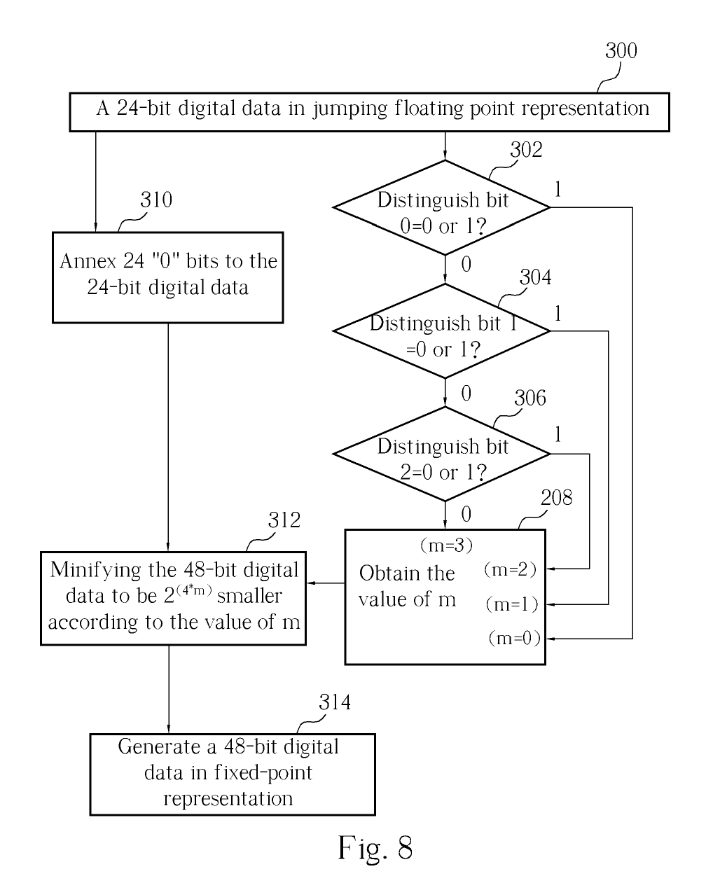

FIG. 8 is another flow chart illustrating a transformation from a 24-bit digital data in jumping floating-point representation into a 48-bit digital data in fixed-point representation according to the present invention. The steps of the flow are described below:
Step 300: Provide a 24-bit digital data in jumping floating-point representation, and proceed to steps 302 and 310 simultaneously;
Step 302: Distinguish the value of bit 0; if the value of bit 0 is 0, proceed to step 304. If the value of bit 0 is 1, proceed to step 308, and set the value of m as 0, which means to determine that a level of the shifting mode is the zero^{th} level N0;
Step 304: Distinguish the value of bit 1; if the value of bit 1 is 0, proceed to step 306. If the value of bit 1 is 1, proceed to step 308, and set the value of m as 1, which means to determine that the level of the shifting mode is the first level N1;
Step 306: Distinguish the value of bit 2; if the value of bit 2 is 0, proceed to step 308, and set the value of m as 3, which means to determine that the level of the shifting mode is the third level N3. If the value of bit 2 is 1, proceed to step 308, and set the value of m as 2 to determine that the level of the shifting mode is the second level N2;
Step 308: According to a tail mark of the 24-bit digital data, cooperating with steps 302-306, obtain the value of m; after the value of m is determined, proceed to step 312;
Step 310: Annex 24 “0” bits to the 24-bit digital data, which then becomes a 48-bit digital data;
Step 312: Reduce the 48-bit digital data obtained from step 310 to be 2^{(4*m)} times smaller according to the value of m after step 308; that is, execute a minifying shift on the 48-bit digital data to shift (4*m) bits; and
Step 314: Generate a 48-bit digital data having the fixed-point representation, and accomplish the transformation from a 24-bit digital data in jumping floating-point representation back to a 48-bit digital data in fixed-point representation.

When implementing each method according to the present invention to hardware, the relative embodiment can be referred in FIG. 2. The DSP 30 shown in FIG. 2 can accomplish the numerical operations (ex. addition, subtraction, multiplication, and division) of numbers in both fixed-point representation and jumping floating-point representation, and perform the transformation between the fixed-point representation and the jumping floating-point representation. That is, the DSP 30 can process short bit-length digital data with a minimum number of quantization errors. The error between the actual result and the ideal result is greatly reduced without increasing the number of bits designed to be processed by the DSP, utilizing a floating-point DSP instead of the DSP 30, and modifying the program code run by the DSP 30. In addition, the short bit-length digital data having the jumping floating-point representation can be stored into an external smaller memory device. In other words, the hardware cost is reduced accordingly.

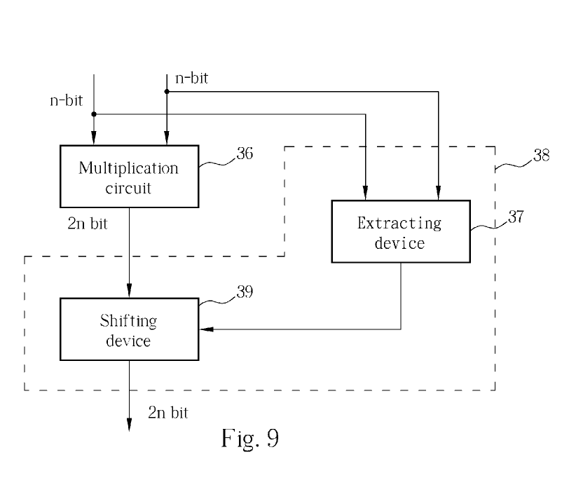

As shown in FIG. 2, the DSP 30 has 3 elements involved in implementing the jumping floating-point arithmetic according to the present invention: the extracting/shifting device 38, the first representation converter 33, and the second representation converter 35. The first representation converter 33 and the second representation converter 35 handle the transformation between the fixed-point representation and the jumping floating-point representation. How the transformation works is clearly disclosed in the embodiments shown in FIGS. 4-8. According to functionality of the extracting/shifting device 38, the extracting/shifting device 38 can be further separated into 2 blocks: an extracting device 37 and a shifting device 39. FIG. 9 is a block diagram illustrating part of the elements within the DSP 30 shown in FIG. 2. Only the extracting device 37, the shifting device 39, and the multiplication circuit 36 are shown in FIG. 9. Suppose that both of two short bit-length digital data (n bits) have the jumping floating-point representation. The multiplication circuit 36 directly multiplies the whole number of these two short bit-length digital data (n bits) because our tail mark can be taken as an estimation of truncated bits. Meanwhile, the two short bit-length digital data are sent to the extracting device 37. The extracting device 37 extracts the tail marks from these two short bit-length digital data, and determines relative information such as a level of the shifting mode and a value of N. The relative information is further sent to the shifting device 39 where the decimal point is shifted corresponding to the level of the shifting mode and the value of N. In the end, the correct long bit-length digital data (2n bits) having the fixed-point representation is successfully obtained.

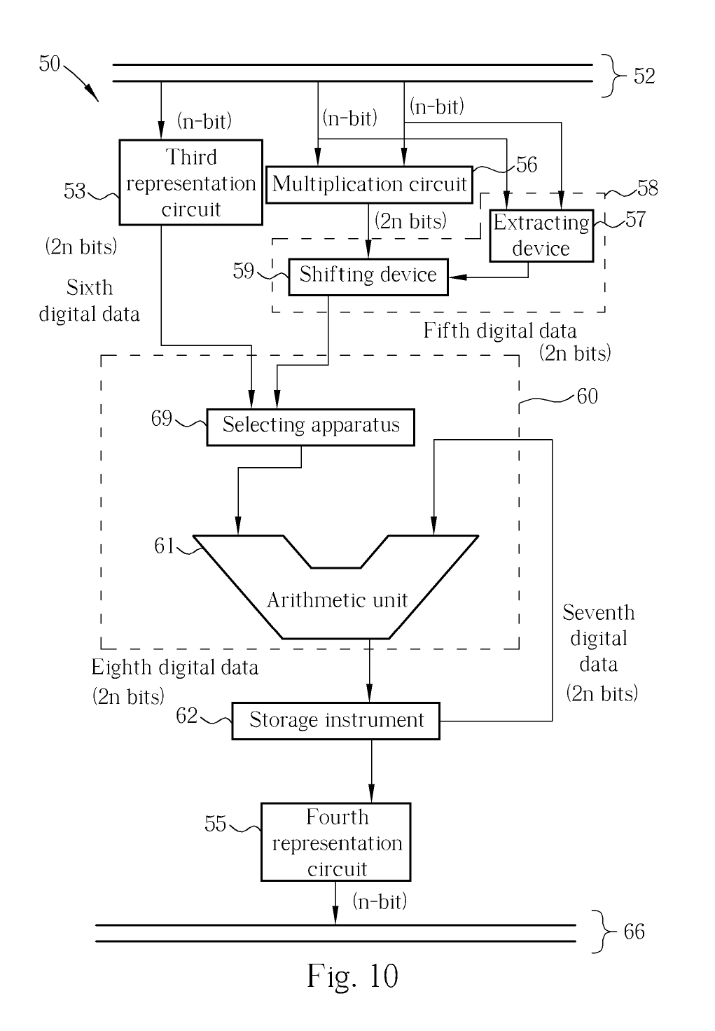

The circuit structure of the embodiment shown in FIG. 2 is not fixed, and can be modified according to different requirements. The following DSP with a certain circuit structure adequately discloses the hardware implementation and the jumping floating-point arithmetic according to the present invention. FIG. 10 is a detailed block diagram illustrating the DSP structure shown in FIG. 2. The DSP 50 shown in FIG. 10 includes a data receiving end 52, a multiplication circuit 56, an extracting device 57, a shifting device 59, a third representation 53, a multiplexing arithmetic module 60, a storage instrument 62, a fourth representation circuit 55, and a data writing-in end 66. The data receiving end 52 receives a plurality of n-bit digital data in jumping floating-point representation. The multiplication circuit 56 is electrically connected to the data receiving end 52 for receiving two n-bit digital data in jumping floating-point representation. It also multiplies the two n-bit digital data to generate a 2n-bit digital data in jumping floating-point representation. The 2n-bit digital data becomes a fifth digital data in fixed-point representation after being processed by the extracting device 57 and the shifting device 59 (these two devices are combined as an extracting/shifting device 58). Meanwhile, the third representation converter 53 electrically connected to the data receiving end 52 also receives an n-bit digital data in jumping floating representation. This n-bit digital data is transformed into a sixth digital data of 2n bits according to the tail mark and the sign bit of this n-bit digital data. The multiplexing arithmetic module 60 includes a selecting apparatus 69 and an arithmetic unit 61. The selecting apparatus 69 electrically connected to the third representation converter 53 and the shifting device 59 is used to choose either the fifth digital data or the sixth digital data as an output; that is, the selecting apparatus 69 can be accomplished by a multiplexer. The arithmetic unit 61 electrically connected to the selecting apparatus 69 is used to receive the output fifth or sixth digital data (2n-bit). The arithmetic unit 61 includes another input end for receiving a seventh digital data consisted of 2n bits sent by the storage instrument 62. Therefore, the arithmetic 61 processes the seventh digital data and one of the first and second digital data (2n bits) in fixed-point representation. This embodiment emphasizes that the digital data be processed by the arithmetic unit 61 is represented in the fixed-point representation because the digital data with jumping floating-point representation experiences a magnifying shift during the transformation and the position of the decimal point has been changed. Therefore, the complexity of performing the addition and the subtraction directly in jumping floating-point representation will be larger than fixed-point number. This means that all the digital data are first transformed into digital data having the fixed-point representation, and then the transformed digital data are sent to the arithmetic unit 61. For the multiplication operation, digital data in jumping floating-point representation are easier to be processed. As described above, the two JFP number can be directly multiplied and the position of the decimal point can be compensated according to the tail marks.

After that, an eighth digital data consisted of 2n bits outputted from the arithmetic unit 61 is sent to the storage instrument 62. The function of the storage instrument 62 is to store a plurality of digital data processed by the multiplexing arithmetic module 60. The storage instrument 62 can be accomplished be an accumulator in practical implementation. The fourth representation converter 55 transforms the 2n-bit digital data in fixed-point representation into an n-bit digital data in jumping floating-point representation, which is written into the previously described memory device by the data writing-in end 66.

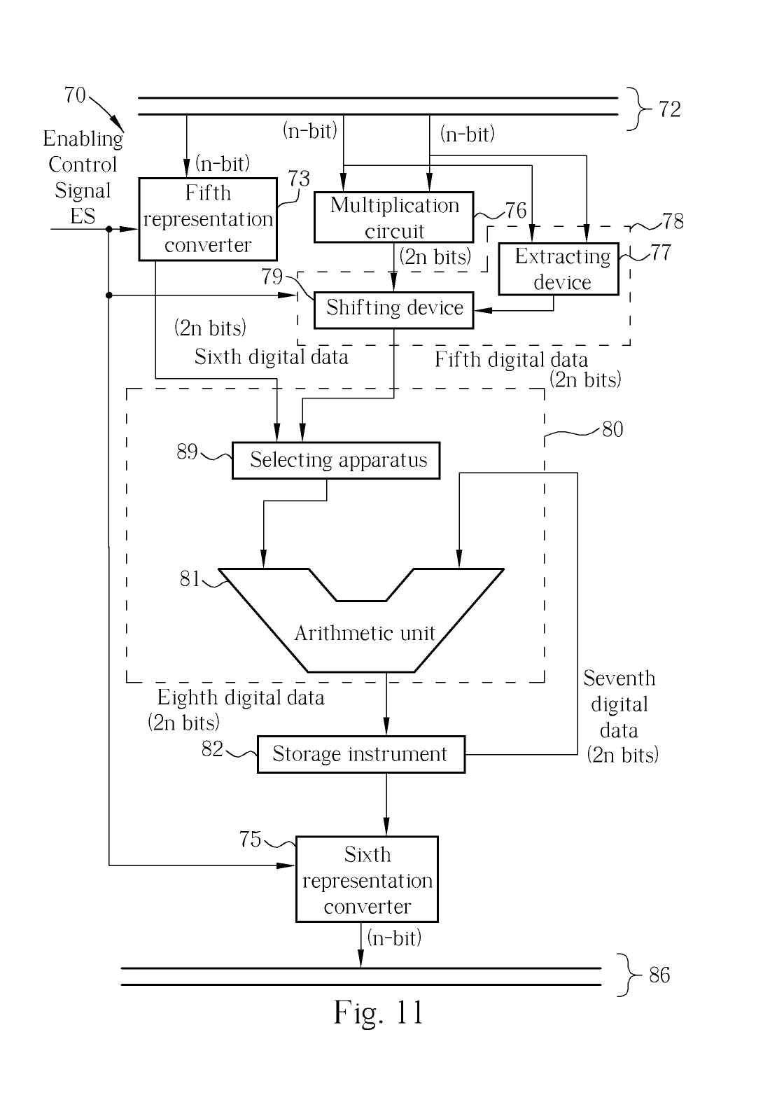

In order to realize the function of the embodiment shown in FIG. 1 into the embodiment according to the present invention so that the DSP can process the data in the fixed-point representation (including the integer representation) and the jumping floating-point representation, an enabling control signal is added to the following embodiment to control if some elements shown in FIG. 10 are enabled. FIG. 11 is another detailed block diagram illustrating the DSP structure shown in FIG. 2. Like the embodiment shown in FIG. 10, the DSP 70 also includes a data receiving end 72, a multiplication circuit 76, an extracting device 77, a shifting device 79, a fifth representation converter 73, a multiplexing arithmetic module 80, a storage instrument 82, a sixth representation converter 75, and a data writing-in end 86. The fifth representation converter 73 and the sixth representation converter 75 corresponds to the third representation converter 53 and the fourth representation converter 55 shown in FIG. 10. The most important feature in this embodiment is that the extracting device 79, the fifth representation converter 73, and the sixth representation converter 75 are connected to at least one enabling control signal ES. This enabling control signal is used to determine if the extracting device 77, the shifting device 79, the fifth representation converter 73 and the sixth representation converter 75, which are all connected to the enabling control signal, should be in JFP mode or in fixed-point mode. When the ES bits are all disabled, the DSP in FIG. 11 can perform like the prior art DSP in FIG. 1. When the representation of either of the two n-bit digital data received by the multiplication circuit 76 is the jumping floating-point representation, the enabling control signal ES will enable the extracting device 77 and the shifting device 79, just like the procedure shown in the embodiment in FIG. 10. When the representation of the two n-bit digital data received by the multiplication circuit 76 is the fixed-point representation, the enabling control signal ES will disable the extracting device 76 and the shifting device 79 can perform like the shifter 18 in prior art. The multiplication circuit generates a 2n-bit digital data in fixed-point representation after multiplying the two n-bit digital data, while the extracting device 77 and the shifting device 79 are combined as the multiplication shifter 18 in the prior art DSP 10 shown in FIG. 1. Similarly, when the enabling control signal ES enables the fifth representation converter 73, the fifth representation converter 73 transforms an n-bit digital data in jumping floating-point representation into a 2n-bit digital data in fixed-point representation, just like the actions of the third representation convert 53 shown in FIG. 10. When the enabling control signal ES disables the fifth representation converter 73, the fifth representation converter 73 will transform an n-bit digital data in fixed-point representation into a 2n-bit digital data in the same representation according to the sign extension and shift operation as well known in the art. Moreover, the function of the fifth representation converter 73 is the same as the first shifting device 14 shown in FIG. 1. Similarly, when the enabling control signal ES enables the sixth representation converter 75, the sixth representation converter 75 transforms a 2n-bit digital data in fixed-point representation into an n-bit digital data in jumping floating-point representation, just like what the fourth representation converter 66 shown in FIG. 10 does. When the enabling control signal ES disables the sixth representation converter 75, the sixth representation converter 75 transforms a 2n-bit digital data with fixed-point representation into an n-bit digital data with fixed-point representation by selecting n bits by programmer's setting. The function of the sixth representation converter 76 is the same as the second shifting device 24 in the prior art DSP 10 shown in FIG. 1.

The invention discloses a new jumping floating arithmetic and jumping floating-point representation that improves number transformation with fewer errors. Fewer repeated bits are used and more effective bits are kept when transforming from a long bit-length digital data into a short bit-length digital data. By the way, the short bit-length digital data is obtained without sacrificing accuracy. The concept of the jumping floating-point representation is introduced into a DSP structure. The digital data are processed and stored in fewer-bit state in a storage instrument when corresponding hardware instrument is implemented. The short bit-length digital data can be transformed back to the original long bit-length digital data with more accuracy and more efficiency. Thus, the quantization errors are greatly reduced without extra resource consumption.

Those skilled in the art will readily observe that numerous modifications and alterations of the device may be made while retaining the teachings of the invention. Accordingly, the above disclosure should be construed as limited only by the metes and bounds of the appended claimed.

1. A digital signal processor (DSP) for processing at least a digital data, the digital data having a plurality of representations, the representations including at least a fixed-point representation and a jumping floating-point representation, the DSP comprising:
a multiplication circuit for multiplying at least two short bit-length data together to generate a long bit-length digital data;
an extracting/shifting device electrically connected to the multiplication circuit for transforming a long bit-length digital data having the jumping floating-point representation into a long bit-length digital data having the fixed-point representation;
a plurality of representation converters, each of the representation converters transforming a specific digital data between the fixed-point representation and jumping floating-point representation through using a jumping floating-point arithmetic; and
an arithmetic unit for processing the digital data.

2. The DSP of claim 1 further comprising a storage instrument electrically connected to the arithmetic unit for storing the digital data.

3. The DSP of claim 1 wherein the jumping floating-point arithmetic is used for transforming a long bit-length digital data having the fixed-point representation into a short bit-length digital data having the jumping floating-point representation, or is used for transforming the short bit-length digital data having the jumping floating-point representation into the long bit-length digital data having the fixed-point representation.

4. The DSP of claim 3 wherein the jumping floating-point arithmetic performs a magnifying shift to shift N bits of the long bit-length digital data having the jumping floating-point representation according to an absolute value of the long bit-length digital data wherein N is an integer not less than zero, eliminate a predetermined number of bits, and sets up a tail mark to generate the short bit-length digital data having the jumping floating-point representation.

5. The DSP of claim 4 wherein a value of N varies in accordance with the absolute value of the long bit-length digital data, the value of N is reduced when the absolute value of the long bit-length digital data is increased, and the value of N is increased when the absolute value of the long bit-length digital data is reduced.

6. The DSP of claim 4 wherein the jumping floating-point arithmetic includes a plurality of displacement modes and each one corresponds to a different value of N.

7. The DSP of claim 6 wherein each digital data comprises one sign bit, and a shifting mode and a value of N corresponding to the shifting mode are determined by comparing the sign bit with other bits of the long bit-length digital data.

8. The DSP of claim 7 wherein the jumping floating-point arithmetic transforms the short bit-length digital data having the jumping floating-point arithmetic into the long bit-length digital data having the fixed-point arithmetic according to the tail mark and the sign bit.

9. The DSP of claim 4 wherein when the two short bit-length digital data inputted into the multiplication circuit correspond to the jumping floating-point representation, the extracting/shifting device transforms the long bit-length digital data having the jumping floating-point representation into the long bit-length digital data having the fixed-point representation according to tail marks of the two short bit-length digital data having the jumping floating-point representation.

10. The DSP of claim 1 wherein the extracting/shifting device and the representation converters are electrically connected to at least an enabling control signal used for controlling if the extracting/shifting device and the representation converters are enabled.

11. The DSP of claim 1 wherein the arithmetic unit is used for processing the digital data having the fixed-point representation.

12. The DSP of claim 1 further comprising:
a data receiving end for receiving the digital data; and
a data writing-in end for storing a short bit-length digital data having the jumping floating-point representation into a memory device.

13. A method applied to a digital signal processor (DSP) for transforming a long bit-length digital data having a fixed-point representation into a short bit-length digital data having a jumping floating-point representation, the method comprising:
(a) performing a magnifying shift to shift N bits of the long bit-length digital data having the fixed-point representation according to an absolute value of the long bit-length digital data, wherein N is an integer not less than zero;
(b) eliminating a predetermined number of bits of the long bit-length digital data after step (a); and
(c) setting up a tail mark to generate the short bit-length digital data having the jumping floating-point representation after step (b), wherein the tail mark corresponds to a value of N.

14. The method of claim 13 wherein the value of N is reduced when the absolute value of the long bit-length digital data is increased, and the value of N is increased when the absolute value of the long bit-length data is reduced.

15. The method of claim 13 further comprising:
(d) in step (a), setting up a plurality of shifting modes, the shifting modes respectively correspond to different values of N;
(e) after step (d), determining a shifting mode and a corresponding value of N and performing a magnifying shift to shift N bits of the long bit-length digital data according to the absolute value of the long bit-length digital data;
(f) in step (c) and after step (e), setting up a tail mark corresponding to the shifting mode.

16. The method of claim 15 wherein the long bit-length digital data comprises a sign bit, and the shifting mode and the value of N corresponding to the shifting mode are determined by comparing the sign bit with other bits of the long bit-length digital data.

17. The method of claim 16 wherein the short bit-length digital data comprises the tail mark, and the short bit-length digital data having the jumping floating-point representation is capable of being converted into the long bit-length digital data having the fixed-point representation according to the tail mark and the sign bit.

18. The method of claim 13 further comprising:
(g) after step (c), storing the short bit-length digital data having the jumping floating-point representation into a memory device.

19. A method applied to a digital signal processor (DSP) for transforming a short bit-length digital data having a jumping floating-point representation into a long bit-length digital data having a fixed-point representation, the short bit-length digital data having the jumping floating-point representation including a tail mark, the method comprising:
performing a minifying shift upon the short-bit digital data to shift N bits according to the tail mark, wherein N is an integer not less than zero; and
adding a predetermined number of bits to the short bit-length digital data.

20. The method of claim 19 wherein the long bit-length digital data comprises a sign bit, and the method further comprising:
determining a value of each bit in N bits according to the sign bit; and
determining a value of each bit in the predetermined number of bits according to the sign bit.

21. The method of claim 19 wherein the tail mark corresponds to a plurality of shifting modes, the shifting modes respectively correspond to different values of N, and the method further comprises determining a shifting mode and a corresponding value of N according to the tail mark.

22. A digital signal processor (DSP) for processing at least a digital data, the digital data having a plurality of representations, the representations including at least a fixed-point representation and a jumping floating-point representation, the DSP comprising:
a data receiving end for receiving at least a short bit-length digital data;
a multiplication circuit electrically connected to the data receiving end for multiplying two short bit-length digital data having the fixed-point representation to generate a long bit-length digital data having the fixed-point representation or multiplying two short bit-length digital data having the jumping floating-point representation to generate a long bit-length digital data having the jumping floating-point representation;
an extracting/shifting device electrically connected to the multiplication circuit for transforming a long bit-length digital data having the jumping floating-point representation into a long bit-length digital data having the fixed-point representation;
a first representation converter electrically connected to the data receiving end for transforming a short bit-length digital data having the jumping floating-point representation into a long bit-length digital data having the fixed-point representation or transforming a short bit-length digital data having the fixed-point representation into a long bit-length digital data having the fixed-point representation;
a multiplexing arithmetic module electrically connected to the first representation converter and the extracting/shifting device for performing selection and computation;
a storage instrument electrically connected to the multiplexing arithmetic module for storing at least a digital data processed by the multiplexing arithmetic module;
a second representation converter electrically connected to the storage instrument for transforming a long bit-length digital data having the fixed-point representation into a short bit-length digital data having the jumping floating-point representation; and
a data writing-in end for storing the short bit-length digital data having the jumping floating-point representation into a memory device.

23. The DSP of claim 22 wherein each digital data comprises a sign bit.

24. The DSP of claim 23 wherein each short bit-length digital data having the jumping floating-point representation comprises a tail mark.

25. The DSP of claim 24 wherein the first representation converter transforms the short bit-length digital data having the jumping floating-point representation into the long bit-length digital data having the fixed-point representation according to the tail mark and the sign bit of the short bit-length digital data having the jumping floating-point representation.

26. The DSP of claim 24 wherein the extracting/shifting device transforms the long bit-length digital data having the jumping floating-point representation into the long bit-length digital data having the fixed-point representation according to the tail mark of the two short bit-length digital data having the jumping floating-point representation.

27. The DSP of claim 22 wherein the second representation converter performs a magnifying shifting to shift N bits of the long bit-length digital data having the fixed-point representation wherein N is an integer not less than zero, eliminates a predetermined number of bits, and sets up a tail mark to generate the short bit-length digital data having the jumping floating-point representation.

28. The DSP of claim 27 wherein a value of N varies in accordance with an absolute value of the long bit-length digital data, the value of N is reduced when the absolute value of the long bit-length digital data is increased, and the value of N is increased when the absolute value of the long bit-length digital data is reduced.

29. The DSP of claim 22 wherein the extracting/shifting device, the first representation converter, and the second representation converter are electrically connected to at least an enabling control signal, and the enabling control signal is used for controlling if the extracting/shifting device, the first representation converter, and the second representation converter are enabled.

30. The DSP of claim 29 wherein the first representation converter transforms the short bit-length digital data having the jumping floating-point representation into the long bit-length digital data having the fixed-point representation when the enabling control signal enables the first representation converter, and the first representation converter transforms the short bit-length digital data having the fixed-point representation into the long bit-length digital data having the fixed-point representation when the enabling control signal disables the first representation converter.

31. The DSP of claim 29 wherein the second representation converter transforms the long bit-length digital data having the fixed-point representation into the short bit-length digital data having the jumping floating-point representation when the enabling control signal enables the second representation converter, and the second representation converter transforms the long bit-length digital data having the fixed-point representation into the short bit-length digital data having the fixed-point representation when the second enabling control signal disables the second representation converter.

32. The DSP of claim 22 wherein the multiplexing arithmetic module is used for selecting and computing at least a long bit-length digital data having the fixed-point representation.

33. The DSP of claim 22 wherein the representations further comprise an integer representation.
